(19) United States
(12) Patent Application Publication
(10) Pub. No.: US 2009/0252570 A1
(43) Pub. Date: Oct. 8, 2009

(54) BENCH ANCHOR

(76) Inventor: ROBIN C. LEE, Ottawa (CA)

Correspondence Address: JOHN S. PRATT;KILPATRICK STOCKTON LLP (L3440), 1100 PEACHTREE STREET, SUITE 2800, ATLANTA, GA, 30309, US

(21) Appl. No.: 12/400,450

(22) Filed: Mar. 9, 2009

Related U.S. Application Data
(60) Provisional application No. 61/035,219, filed on Mar. 10, 2008.

(51) Int. Cl. F16B 13/04

(52) U.S. Cl. 411/15

(57) ABSTRACT

A workbench anchor utilizing counter acting wedges configured to expand laterally as they are drawn together longitudinally in order to lock the anchor in a workbench dog hole or other suitably sized hole by tightening a screw that passes through one wedge and into a threaded hole in a second wedge. Another threaded hole in the anchor can receive a screw or bolt for securing work pieces, jigs, fixtures or other structures to the anchor and, thereby, to the bench in which the anchor or anchors are mounted. An optional O-ring or other friction-increasing structure facilitates securing the anchor in and removing the anchor from the workbench by preventing the anchor from falling through the dog hole or other hole in which it is being positioned or from which it is being removed.

### CROSS REFERENCE TO RELATED APPLICATION

This application claims priority to U.S. Provisional Patent Application Ser. No. 61/035,219, for a Bench Anchor, filed Mar. 10, 2008, which is incorporated by reference.

### FIELD OF THE INVENTION

This invention relates to woodworking benches and devices attached to or anchored in such benches for holding work pieces, jigs, fixtures and the like that need to be temporarily secured to a bench or other structure.

### BACKGROUND OF THE INVENTION

Workbenches have probably been in use for at least thousands of years, and some of the woodworking bench designs in use today date back at least hundreds of years. Benches are used to support and, frequently, hold work pieces, jigs or fixtures during use. A substantial number of work piece, jig or fixture holding accessories are commonly used with woodworking benches, including, vises of several types, bench dogs, hold-downs, surface clamps, and a variety of other such accessories. Generally, such workbench accessories are designed to exhibit great strength and holding power to enable them to resist significant force as a work piece is shaped, sawn or otherwise worked. For applications where the user or the device being held exerts little or no force, such devices are often larger and more expensive than they need be, if they are usable at all.

Furthermore, many of these conventional accessories have a fixed configuration and are usable only in a limited number of ways. Notwithstanding the substantial number of such accessories, there is frequently a need for a work piece, jig or fixture holding device or structure with a different or more versatile structure than those currently available. Frequently, this need could be filled with relocateable attachment points. Accordingly, there remains a need for a versatile work piece securing device for temporary use with a workbench.

Most existing woodworking benches have holes penetrating at least the bench top, sometimes one or more of the bench legs and one or more of the cheeks of the vise or vises mounted on the bench. These holes are intended to receive bench dogs, which are metal or wood pins that may be inserted in holes for securing work pieces, such as between a bench dog in a bench top and a second bench dog in the movable cheek of a vise attached to the bench. Most such dog holes in early benches were square or rectangular, but many more recently manufactured benches use round dog holes and round bench dogs because of a number of benefits associated with such devices.

The availability of dog holes in existing benches makes it attractive to utilize those holes for securing work pieces, jigs and fixtures.

### SUMMARY OF THE INVENTION

A threaded opening in a bench is a more appropriate solution than most conventional holding structures for the light duty clamping and fixturing needs that need only resist vibration, gravity or relatively light force. Furthermore, such threaded anchors can be more versatile, easier to use, require smaller tools and are less expensive than many of the alternatives.

The workbench anchors of this invention are generally cylindrical, square or rectangular structures utilizing two cooperating wedges that can be easily inserted in a woodworking bench dog hole and removably secured therein. A screw or bolt can then be threaded into a threaded hole in the anchor for the purpose of securing work pieces, jigs, fixtures or other structures to the anchor and, thereby, to the bench in which the anchor or anchors are mounted. When no longer needed, the work piece, jig or fixture can be readily detached from the anchor by removal of the screw or bolt that secures it, and rotation of a screw within the anchor quickly and easily permits its removal from the hole in the bench within which its positioned. An O-ring of resilient material encircling the anchor or an alternative structure serving the same friction-increasing function may be used to facilitate installation and removal of the anchor by engaging the wall of the bench dog hole to prevent the anchor from slipping out of position when the anchor locking screw is not tight.

Other embodiments of the anchor of this invention may use a long screw for actuating the wedging action that rotates inside a threaded tube attached to one of the wedges so that the anchor may be secured in a blind or other hole in a first object by rotating the long screw to actuate the wedging action, and the first object may then be secured to a second object through which the threaded tube passes with a wingnut or other threaded fastener rotated on the threaded tube.

### BRIEF DESCRIPTION OF THE DRAWINGS

FIG. 1 is an exploded perspective view of one embodiment of the bench anchor of this invention.

FIG. 2 is a side view of the assembled bench anchor shown in FIG. 1.

FIG. 3 is a section view taken along line 3-3 in FIG. 2.

FIG. 4 is an end view of the assembled bench anchor shown in FIG. 1.

FIG. 5 is an enlarged detail taken at circle 5 in FIG. 3.

FIG. 6 depicts an alternative embodiment of the anchor of this invention that has a rectangular (specifically a rectangle that is square) cross section.

FIG. 7 is a perspective view of another alternative embodiment of the anchor of this invention.

FIG. 8 is another side view, partially in section of the anchor of this invention depicted in FIG. 7.

### DETAILED DESCRIPTION

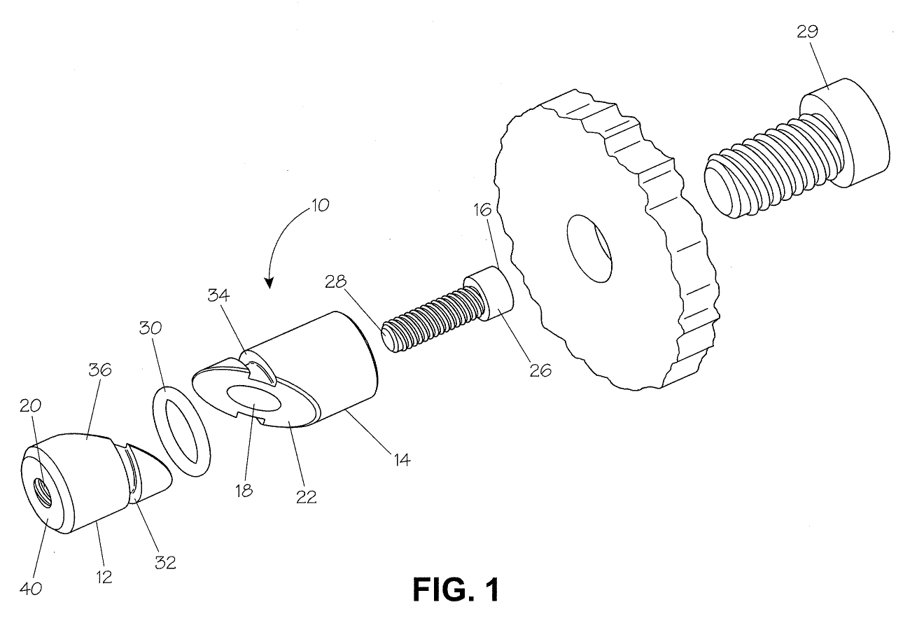

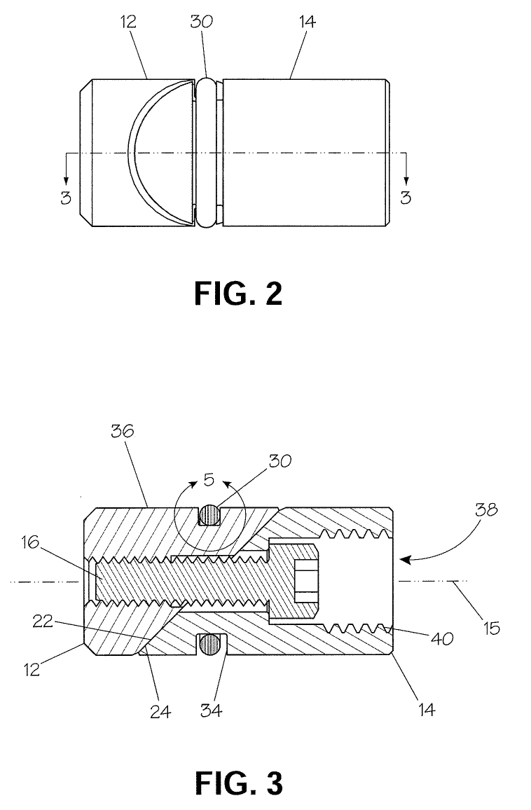

As will be appreciated by reference to the figures, particularly including FIG. 1, the first embodiment 10 of the bench anchor of this invention is a counter wedge structure that may be locked within a hole or tube of appropriate depth and diameter. Anchor 10 is intended for use in a round dog hole (which may be a blind hole) and incorporates a pair of cylindrical members—a base 12 and a head 14. A screw 16 passes through a recessed, oversize hole 18 in the head 14 and into a threaded hole 20 in base 12. Contacting surfaces 22 (of head 14) and 24 (of base 12) are tilted by approximately 45 degrees relative to the longitudinal axis 15 of the head 14 and base 12. The oversized hole 18 in head 14 through which screw 16 passes allows head 14 to move laterally relative to screw 16. As a result, when screw 16 is tightened into threaded hole 20 of base 12, thereby drawing head 14 and base 12 together, head 14 slides laterally relative to base 12 until such movement is stopped by contact between the wall of hole 18 and the shank 24 of screw 16 and or between other structure of head 14 and screw head 26. Objects like work pieces, jigs or fixtures may be secured to the bench or other device within which the anchor 10 is secured with a screw 29 that is threaded onto threads 40 in head 14.

When the screw 16 is tightened, this structure allows the two counter wedge members, base 12 and head 14, to slide against each other while maintaining contact between the tilted surfaces 22 and 24. The screw 16 thereby converts coaxial motion associated with rotating the screw into lateral separation of the two wedge members head 14 and base 12. The geometry of the screw 16 and head 14 also limits the amount of lateral movement possible. A O-ring 30 of neoprene or other resilient, relative high-friction material is captured within an angular groove formed by groove 32 in base 12 and groove 34 in base 14.

Groove 32 in base 12 is as wide as the diameter of O-ring 30 but not quite as deep so that O-ring 30 protrudes by a nominal amount “x” easily seen in FIG. 5 and therefore projects beyond the cylindrical surface 36 of base 12. Groove 34 in head 14 is as deep as the diameter of O-ring 34 and is wider than O-ring 34 by the amount of vertical travel that head 14 can achieve relative to base 12. With this structure, when screw 16 is tightened and the counter wedges base 12 and head 14 move laterally relative to each other, the outer diameter of the O-ring is increased at roughly the same rate and remains larger than the overall “cylindrical” structure by about the same nominal amount. This permits the user to set or adjust the desired friction between the anchor 10 and the hole into which it is placed. At the same time, this allows the O-ring 30 to provide friction in a larger range of diameters than would normally be possible with an O-ring 30 installed within a groove of fixed dimensions. The additional width of the groove 34 in head 14 keeps the O-ring 30 from being pinched between the sliding members 12 and 14 as they move longitudinally relative to each other.

At least a portion of the recess 38 in head 14 is machined with threads 40. This permits a screw or bolt to be threaded into the head 14 of anchor 10 after it has been positioned in a dog hole in a workbench or another appropriate structure.

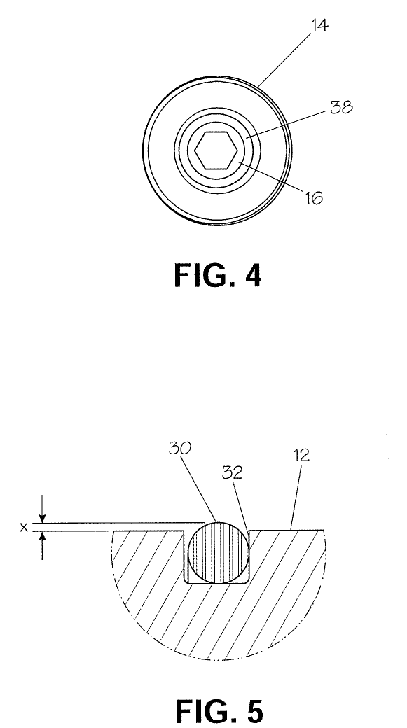

The anchor 10 can be dropped into a dog hole from the top of the workbench and locked in placed using a hex recess or Allen wrench if screw 16 is an Allen head cap screw as shown in FIGS. 1, 3 and 4 or with an appropriate screwdriver if a different screw head is utilized. This provides a nonpermanent, reusable anchor that can be attached to a workbench or other structure if only one side of a hole in the workbench or other structure is accessible or if it is a blind hole. Incorporation of the O-ring 30 in the structure of the anchor 10 significantly improves the utility of the anchor 10. A similar anchor without the O-ring is prone to fall through a dog hole in a bench or other structure if the anchor 10 is not held in place from below, which is often difficult or impossible.

The O-ring 30 also facilities locking the anchor 10 by resisting the tendency that anchor 10 might have to rotate within the dog hole as screw 16 is tightened.

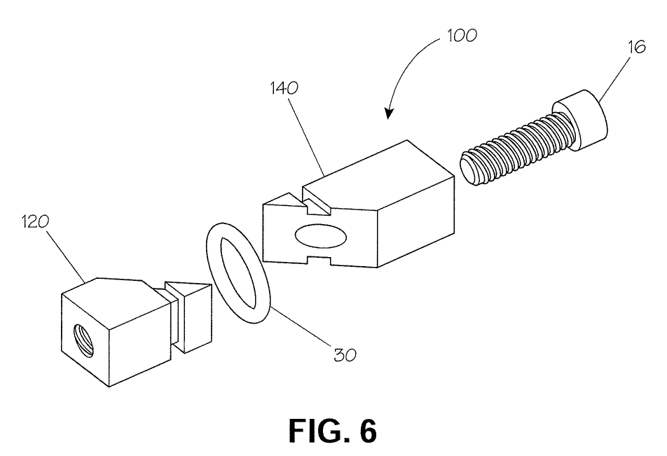

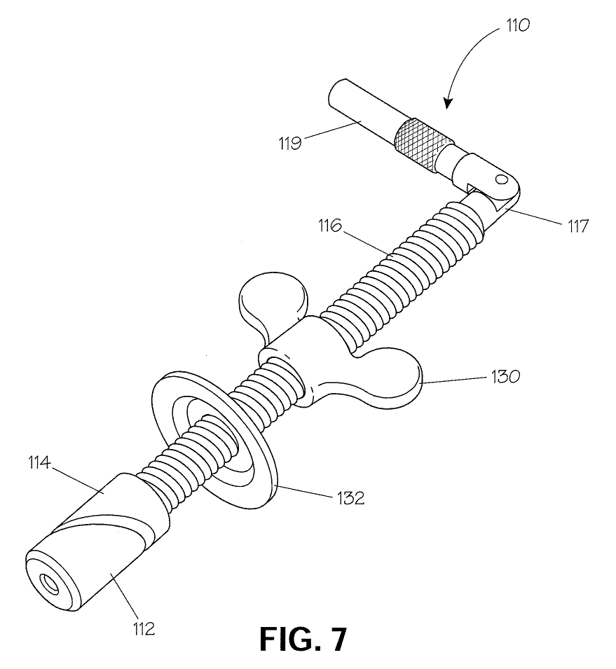

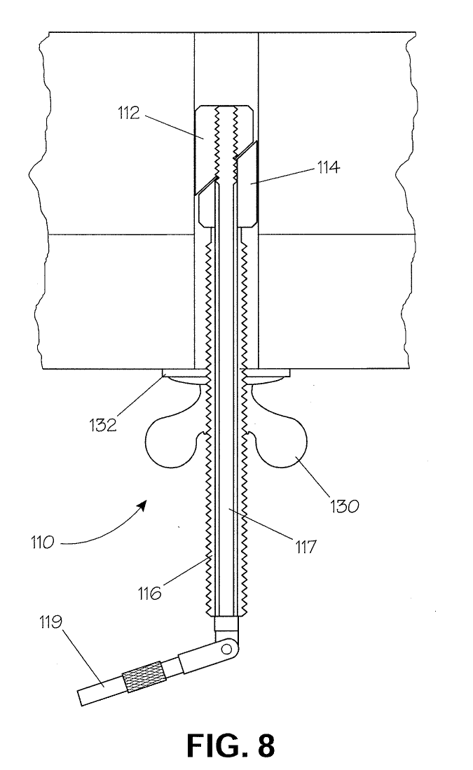

Because of the configuration of the O-ring, it is effectively made larger by turning screw 26 to draw head and base 12 together. This enables the user to place the O-ring portion of the anchor within a dog hole while holding the head 14, as illustrated in FIG. 6. The screw 16 is then rotated to increase friction until the anchor 10 will no longer fall freely into or through the dog hole, but screw 16 is not rotated so much that it cannot be pushed down by the user to a position flushed with the surface of the workbench, as is illustrated in FIG. 7. Anchor 10 can then be locked in place by further tightening screw 16, as is illustrated in FIG. 8.

While the anchor 10 and other embodiments of this invention can be produced in a wide variety of sizes and configurations and of a wide variety of materials, a desirable diameter for the base 12 and head 14 of the cylindrical embodiment 10 illustrated in the figures (and intended for use in a round dog hole) is 0.740 inches. This provides 0.010 inches of clearance within a ¾ inch dog hole. Among other materials useable for the base 12 and head 14 are low malleability materials such as steel, iron, brass or engineering plastics. In a well-functioning nominally ¾ inch diameter anchor 10, the O-ring 30 can protrude from groove 32 by an amount “x” (see FIG. 5) of approximately 0.015 inches. For instance, the diameter of the O-ring 30 material may be 0.103 inches, and the depth of groove 32 can be 0.088 inches. Different amounts of protrusion may be desirable depending on the nominal diameter and weight of the anchor 10 and depending on the properties of the O-ring 30 and possibly other considerations such as the material and finish of the structure in which the anchor 10 is used.

While brass, bronze and other materials can be used, the screw 16 should typically be made of steel to provide enough strength to avoid breaking during use in an anchor structure of the size described immediately above. A desirable diameter for the screw 16 is ¼ inch, and it may, for instance, be a ¼-20 UNC screw.

The O-ring 30 should preferably be made of a medium durometer EPDM (ethylene propylene diene monomer) rubber. Utilizing an anchor 10 of the above described dimensions, nominally ¾ inch in diameter, the recess 38 having threads 40 should desirably be nominally a ½ inch threaded opening such as a ½-13 UNC.

In the embodiment 10 of the anchor of this invention described above and depicted in the drawings, the O-ring 30 projects from the base 12 and is fully recessed within the head 14. This configuration appears to function better than the reverse with the O-ring 30 projecting from head 14 and recessed within base 12. However, this alternative achieves the same basic function and can be used. As is described above and shown in the figures, the groove 34 in head 14 is wider than the O-ring 30. This provides space for the O-ring 30 to move when the base 12 and head 14 wedges slide against each other and the grooves 32 and 34 no longer line up. Similar function could be achieved with equal-width grooves but with the lead-in at the mating wedge surface 22 and 24 heavily rounded to prevent severing of the O-ring 30. Alternatively, both grooves 32 and 34 could wider than the O-ring 30, thus providing space for it to move about.

In the embodiment 10 described and depicted herein, the O-ring 30 encircles the entire structure. This provides and anchor 10 that can accommodate greater variations in dog hole sizes. However, the O-ring 30 can be placed within a groove that is entirely contained within one of the base 12 or head 14, provided that dog hole diameter is tightly controlled.

The sloped surfaces 22 and 24 may be at a 45° angle with respect to the longitudinal axis 15, as illustrated in the figures. This angle is somewhat arbitrary. Angles between approximately 45° and 60° would be equally functional, although some angles may be more prone to jamming. Angles less than 45° would also be usable, but would necessitate greater vertical travel and thus longer parts.

In the described embodiment 10, the thread 40 in the head 14 is illustrated as ½-13. Smaller diameter threads would be possible, particularly if the head 14 is made in two components so that the head of screw 16 can be captured between those two components.

Furthermore, the described anchor embodiment 10 is designed in such a way as to locate the clamping force-applying mechanism (the screw 16) and the hardware-receiving thread 40 in the same component (head 14) to facilitate use of the anchor 10 blind applications and with single-sided installation. The anchor of this invention could be made to work equally well with the screw 16 passing through base 12 and threaded into head 14. Such a configuration would achieve the same function with the only difference being the location of the screw 16 (and, therefore, with the need to access screw 16 from the side opposite than into which a fixture-mounting screw is fastened in hole 38.

In another alternative to the embodiment 10 of this invention described above and depicted in the figures, a screw for securing a work piece, jig or fixture to the anchor 10 could be threaded into the other end of the same threaded hole 20 that receives the anchor securing screw 16 if base 12 is long enough to fully receive screw 16 without filling hole 20. With a suitably long base 12, the hole 20 could be a stepped opening with a larger threaded hole proximate the flat end 40 of base 12, and a smaller threaded hole for receiving screw 16 proximate the sloping surface 24.

The illustrated embodiment 10 of the anchor of this invention uses counter-wedges to lock the anchor 10 within the dog hole. Alternatively a large compressible O-ring or rubber tube could be clamped between two anchor members having square ends so that such compression expands the O-ring or rubber tube diametrically, thereby fixing it within the dog hole.

As is described above, the embodiment 10 of this anchor is typically designed to operate within a ¾″ round dog hole. However, appropriately sized, otherwise comparable anchors could be used in round dog holes of other diameters. Furthermore, another alternative embodiment would be made using square or rectangular cross section counter-wedges for use in square or rectangular dog holes, a hole shape found on many older benches and some benches still being manufactured. Such a square cross section embodiment 100 of the anchor of this invention is illustrated in FIG. 18, where the base 120 is attached to a head 120 with a screw 16, and an O-ring 30 encircles these components and seats in a groove 340 in head 140 and a groove 320 in base 120.

The present embodiment calls for the O-ring to project from the lower wedge and to be recessed within the upper wedge. However, the same function could be achieved it the O-ring projected from both wedges. The drawback to this configuration is a limitation on the smallest compatible dog hole size.

The O-ring 30 is used to prevent the anchor 10 from falling too deeply into or though a dog hole. Alternatively head 14 could be formed with a shoulder of greater diameter than the dog hole, or a washer or other structure could be attached to the top of the head 14. In yet another alternative, a wire or leaf spring could be used as they are on some conventional bench dogs to prevent them from falling through a dog hole. Such a spring could also be incorporated into the anchors of this invention.

The anchor 10 of this invention can be used to attach to a woodworking bench a wide variety of structures, including, for instance, a work piece support, drying rack, a miter box, a sling jig, a carving mount, a shooting board, a sanding down-draft cabinet, and a spring-dampened motor mount.

An embodiment of this invention particularly useful for securely attaching large objects like carving work pieces to workbenches is depicted in FIGS. 7 and 8.

Anchor 110 is intended for use in a round hole such as a hole in the bottom of a work piece. Anchor 110 incorporates a pair of cylindrical members—a base 112 and a head 114. An externally threaded tube screw 116 is attached to head 114. A rod 117 having a handle 119 on one end passes through tube screw 116, and the other end of rod 117, which is threaded, is received in a threaded hole 120 in base 112.

As will be appreciated by reference to the descriptions of other embodiments above, rotation of rod 117—drawing base 112 toward head 114—causes head 114 and base 112 to slide laterally relative to each other, thereby locking them in a work piece or other hole-containing object within which the head 114 and base 112 are positioned.

With the anchor 110 base 112 and head 114 secured within a work piece or other object on one side of a workbench top or other structure, and with threaded tube 116 passing through the workbench top, rotation of wingnut 130 on threaded tube 116 against washer 132 will secure the anchor 110 and the object to which it is attached to the workbench.

As will be appreciated from these descriptions and the accompanying drawings of alternative embodiments of the anchors and attached structures of this invention, numerous variations and modifications can be incorporated in the anchors and anchor-utilizing structures of this invention without departing from the spirit of this invention or the scope of the following claims.

1. An anchor for temporary mounting within a hole in a workbench or other structure, the anchor comprising two counter acting wedges that move laterally relative to each other as they are drawn together longitudinally, wherein at least one of the wedges has a threaded hole within which a screw can be positioned after the anchor is secured within the hole.

2. The anchor of claim 1, further comprising a high-friction structure positioned on at least one of the wedges for contact with the workbench within the hole.

3. An anchor for temporary mounting within a round hole in a workbench or other structure, the anchor comprising
(a) two cylindrical, counter-acting wedges that have abutting faces oblique to a longitudinal axis of the wedges, and one of the wedges having a first threaded hole,
(b) a screw passing through an over-size hole in one of the wedges and into a second threaded hole in the other of the wedges to draw the wedges together by tightening the screw, and
(c) an O-ring having a diameter and encircling the assembled wedges and screw.

4. The anchor of claim 3, wherein the first threaded hole is in the wedge having the over-size hole.

5. The anchor of claim 3 wherein each of the wedges has a groove having a width and a depth for receiving a portion of the O-ring penetrating its cylindrical face.

6. The anchor of claim 5, wherein the depth of the groove in the wedge having the second threaded hole is not as deep as the diameter of the O-ring.

7. The anchor of claim 6, wherein a width of the groove in the wedge not having the second threaded hole is wider than the diameter of the O-ring.

8. An assembly comprising a work support attached to a workbench with at least one anchor of claim 1.

9. An anchor for temporary mounting within a round hole in a workbench or other structure, the anchor comprising
(a) two cylindrical, counter-acting wedges that have abutting faces oblique to a longitudinal axis of the wedges, and one of the wedges having a first threaded hole and an over-size hole, and
(b) a screw passing through the over-size hole and into a second threaded hole in the other wedge to draw the wedges together by tightening the screw, and
(c) an O-ring having a diameter and encircling the assembled wedges and screw, wherein and each of the wedges has a groove having a width and a depth for receiving a portion of the O-ring penetrating its cylindrical face and wherein the depth of the groove in the wedge having the second threaded hole is not as deep as the diameter of the O-ring and wherein a width of the groove in the wedge not having the second threaded hole is wider than the diameter of the O-ring.

10. An anchor for temporary mounting within a blind hole in a first object, the anchor comprising two counter acting wedges that move laterally relative to each other as they are drawn together longitudinally by rotation of a first screw passing through one of the wedges and threaded into the other wedge, and a second screw attached to the one wedge for securing the first object to a second object with a wingnut acting against a washer bearing against the second object, through which the second screw passes.

11. The anchor of claim 10, wherein the second screw is hollow and at least partially surrounds and is co-axial with the first screw.

12. An anchor for temporary mounting within a hole in a workbench, work piece or other structure, the anchor comprising
a) two cylindrical sections having opposed oblique surfaces that slide against each other, forcing the two sections to move laterally relative to each other as they are drawn together longitudinally by
b) a screw passing through a first of the two sections and threaded into the second section, and
wherein the first section is adapted to receive a threaded connector for securing the anchor to an object.

13. The anchor of claim 12, wherein the adaptation of the first section to receive a threaded connector in an internal thread for receiving a bolt or a second screw.

14. The anchor of claim 12, wherein the adaptation of the first section is a smooth hole within which an end of a threaded tube is secured.
